(19) United States
(12) Patent Application Publication
(10) Pub. No.: US 2008/0080751 A1
(43) Pub. Date: Apr. 3, 2008

(54) Method of capturing fingerprint image

(75) Inventors: Chap-Meng Bee, Jhunan Township (TW); Jer-Chuan Huang, Yijhu Township (TW)

Correspondence Address: TROXELL LAW OFFICE PLLC, SUITE 1404, 5205 LEESBURG PIKE, FALLS CHURCH, VA, 22041, US

(73) Assignee: WISON TECHNOLOGY CORP.

(21) Appl. No.: 11/540,977

(22) Filed: Oct. 2, 2006

(51) Int. Cl. G06K 9/00

(52) U.S. Cl. 382/124

(57) ABSTRACT

A method of capturing a fingerprint image comprises the steps of: (1) putting a finger in front of a camera; (2) determining whether a fingerprint is located within an image capture region of the camera; (3) if “No”, adjusting the position of the camera or finger and returning to the step 2; (4) if “Yes”, capturing a fingerprint image; (5) transforming the fingerprint image from a colored fingerprint image into a gray scale fingerprint image; (6) binarizing the gray scale fingerprint image; (7) thinning the gray scale fingerprint image; and (8) extracting a fingerprint template. By the use of aforesaid steps, the fingerprint image can be captured by the camera.

### FIELD OF THE INVENTION

The present invention relates to a method of capturing a fingerprint image, and more particularly to a fingerprint image capture method applicable to an apparatus such as a notebook computer, a mobile phone, or the like that equips with a video camera or a web camera for identity recognition.

### BACKGROUND OF THE INVENTION

With the development of technology, the identity recognition nowadays is always an extremely concerned issue in the fields of criminal investigation, residence, factory, or commerce. There are several ways to recognize the identity. The utilization of biometric recognitions is fairly common in recognizing someone's identity since every individual has unique fingerprints and irises. Besides, the fingerprint recognition is a more precise technique among the biometric recognitions.

Generally speaking, a fingerprint capture device must be utilized in the fingerprint recognition to read the fingerprint, and the read fingerprint data are compared with the existing fingerprint data. The follow-up actions can be performed only when the comparison result shows that they are matched. On the contrary, the follow-up actions can not be performed if the comparison result shows that they are not matched. In this regard, the data security can be thus promoted.

No matter what field the fingerprint recognition is applied, the utilization of the external fingerprint capture device is unavoidable. Besides, there are many portable electronic products nowadays to achieve the purposes of inputting, processing and storing data, and they are also equipped with cameras for capturing images. Nevertheless, these cameras of these electronic products are only designed for photographing scenery. If it is desired to add the identity recognition systems to these electronic products, the additional fingerprint capture device still must be added thereto. Thus, it is extremely inconvenient.

In view of the foregoing description, the motive of the present invention is to provide the general public with a method of capturing a fingerprint image effectively by a camera instead of a fingerprint capture device to provide the electronic product that equips with the camera with the function of identity recognition for promoting security.

### SUMMARY OF THE INVENTION

It is a major object of the present invention to provide a method of capturing a fingerprint image effectively by a camera instead of a fingerprint capture device.

It is a minor object of the present invention to provide a method of capturing a fingerprint image by a camera of an electronic product so as to promote security effectively.

In order to achieve the above-mentioned object, a method of capturing a fingerprint image is comprised of the steps of:

(1) putting a finger in front of a camera;

(2) determining whether a fingerprint is located within an image capture region of the camera;

(3) if “No”, adjusting the position of the camera or finger and returning to the step 2;

(4) if “Yes”, capturing a fingerprint image;

(5) transforming the fingerprint image from a colored fingerprint image into a gray scale fingerprint image;

(6) binarizing the gray scale fingerprint image;

(7) thinning the gray scale fingerprint image; and

(8) extracting a fingerprint template.

By the use of aforesaid steps, the fingerprint image can be captured by the camera.

The aforementioned objects and advantages of the present invention will be readily clarified in the description of the preferred embodiments and the enclosed drawings of the present invention.

### BRIEF DESCRIPTION OF THE DRAWINGS

FIG. 1 is a flow diagram showing the main framework of the present invention.

FIG. 2 is a schematic diagram showing that the present invention is applied to a mobile phone.

FIG. 3 is a schematic diagram showing that the position of the fingerprint is determined non-automatically.

FIG. 4 is a schematic diagram showing that the position of the fingerprint is determined automatically.

FIG. 5 is a schematic diagram showing the fingerprint template of the present invention.

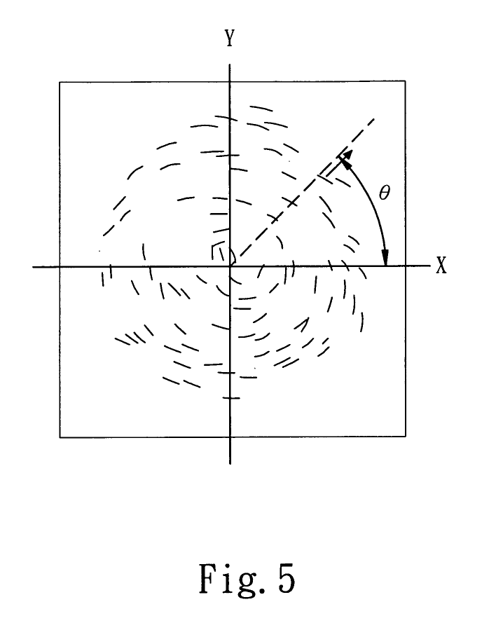

### DETAILED DESCRIPTION OF THE PREFERRED EMBODIMENT

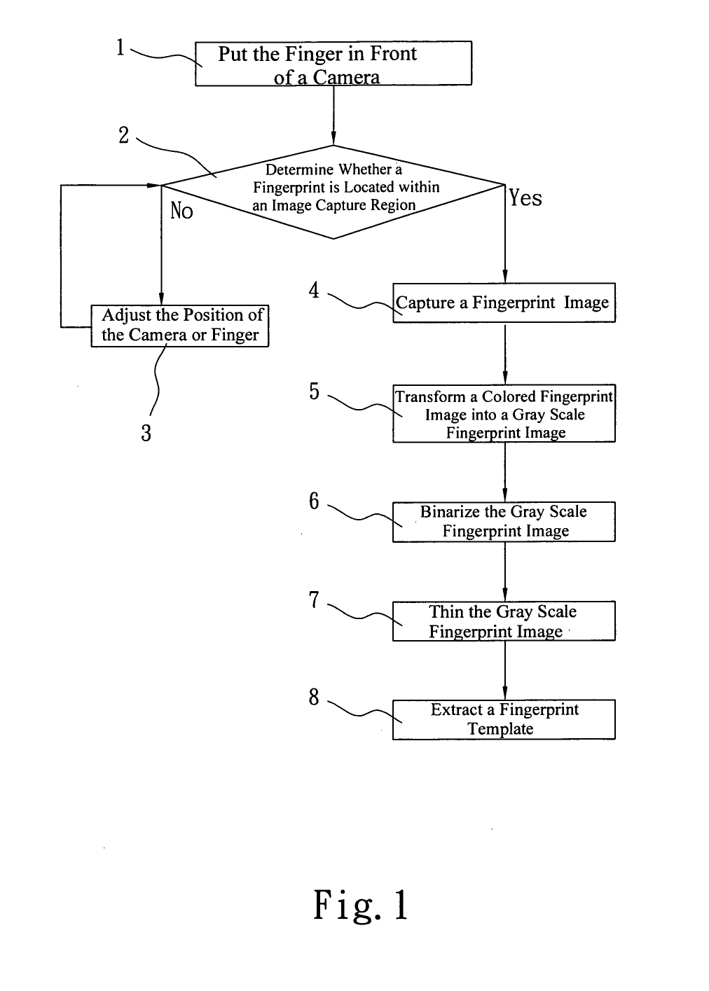

Referring to FIG. 1, a flow diagram of the main framework of the present invention is shown. The method of capturing a fingerprint image comprises the steps of:

(1) putting the finger in front of a camera;

(2) determining whether a fingerprint is located within an image capture region;

(3) if “No”, adjusting the position of the camera or finger and returning to the step 2;

(4) if “Yes”, capturing a fingerprint image;

(5) transforming the fingerprint image from a colored fingerprint image into a gray scale fingerprint image;

(6) binarizing the gray scale fingerprint image;

(7) thinning the gray scale fingerprint image; and

(8) extracting a fingerprint template.

In accordance with the above-mentioned steps, the fingerprint image is captured by a camera instead of a fingerprint capture device.

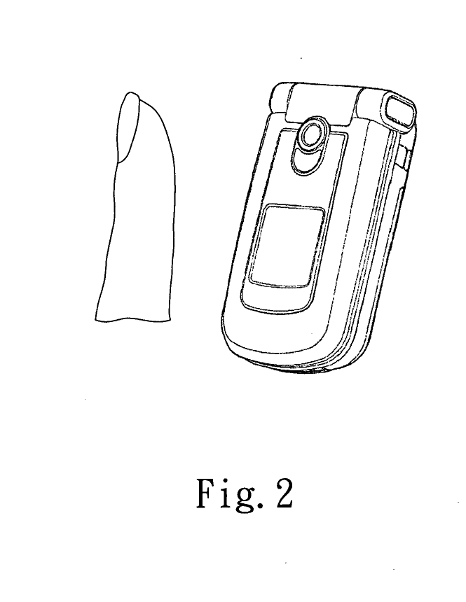

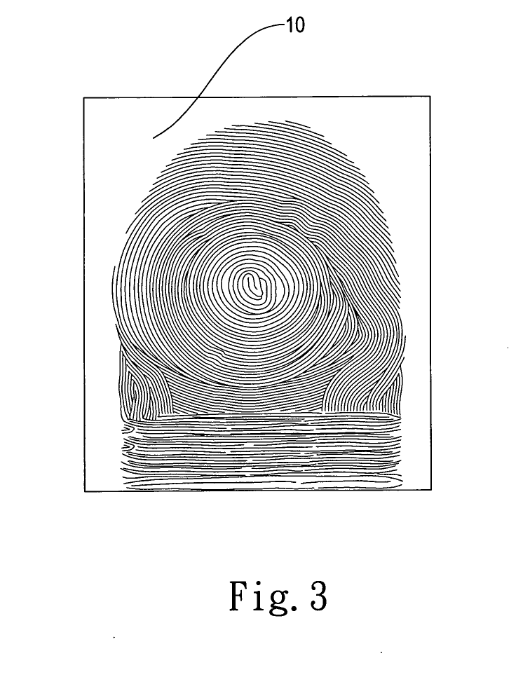

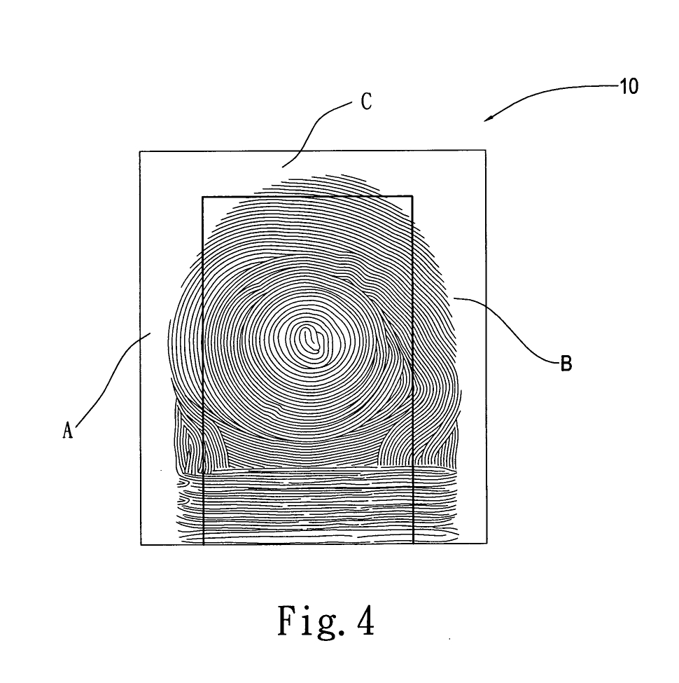

So far, quite a few electronic products, for example, mobile phones, digital camera, notebook computer, and so on, are equipped with video cameras or web cameras. For the purpose of explanation, this preferred embodiment of the present invention is exemplified by the mobile phone. Referring to FIGS. 2 and 3 simultaneously, after turning on the mobile phone, and if it is desired to read the data stored into the mobile phone, a display screen of the mobile phone shows an image capture region 10 inside which an image capture frame is formed. Besides, the image capture frame is in the shape of, for example, a circle, a rectangle, a square, or an irregular. In addition, the image capture frame may be alternatively composed of positioning dots or symbols. For the purpose of confirming the user's identity, the user must put his finger on a location in front of the camera first, and then determine whether the finger is located within the image capture region 10 through the display screen, as shown in FIG. 3, so as to complete the initial positioning. If the finger is not completely located within the image capture region 10, either the finger or the mobile phone must be adjusted until the finger is located within the image capture region 10. After the finger is located in the image capture region 10, the image capture region 10 notices the user by showing different colors. For example, the image capture region 10 may be changed from a red color to a green color. Alternatively, the image capture region 10 may be chosen by a picking method. At this moment, for the purpose of capturing a fingerprint image, the camera is in an auto-adjustment mode that provides the functions of AE (Auto Exposure), AF (Auto Focus) and AWB (Auto White Balance). Referring further to FIG. 4, the camera captures a complete fingerprint image only when the borders of the fingerprint image are detected to be indeed located on bilateral blank portions A and B and an upper blank portion C of the image capture region 10. In other words, the complete fingerprint image is not captured until the detailed positioning is completed.

Furthermore, the captured colored fingerprint image is transformed into a gray scale fingerprint image by the internal program of the mobile phone. Next, the gray scale fingerprint image is binarized, and the binarized gray scale fingerprint image is then thinned. Next, a set of fingerprint minutiae, called template, is extracted from the thinned fingerprint image. The data structure of the minutia is indicated by (X, Y, θ), wherein (X, Y) are two-D planar coordinates of the fingerprint minutia, and θ is the direction angle of the fingerprint minutia. After obtaining the fingerprint template, the fingerprint template can be stored in the mobile phone. Alternatively, this fingerprint template can be optionally further compared with the enrolled fingerprint data, which are stored in the mobile phone before, so that the data stored in the mobile phone are accessible only when the comparison result shows that they are matched entirely. Accordingly, the data security can be thus promoted.

In accordance with foregoing description, the method of the present invention has the following advantages:

1. The purpose of capturing the fingerprint image can be achieved by using the built-in camera of the apparatus directly such that it is very convenient and cost-saving since no additional fingerprint capture device is required.

2. The data stored in the electronic product, which is equipped with the camera, can be more secure.

In summary, the present invention indeed achieves the anticipated objects by disclosing a method of capturing a fingerprint image, in which the fingerprint image is captured by the camera directly and the captured fingerprint image transformed so as to extract a fingerprint template therefrom for performing an authentication such that the data stored in the electronic product, which equips with the camera, can be more secure. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A method of capturing a fingerprint image comprising the steps of:
(1) putting a finger in front of a camera;
(2) determining whether a fingerprint is located within an image capture region of said camera;
(3) if “No”, adjusting a position of said camera or finger and returning to said step 2;
(4) if “Yes”, capturing a fingerprint image;
(5) transforming said fingerprint image from a colored fingerprint image into a gray scale fingerprint image;
(6) binarizing said gray scale fingerprint image;
(7) thinning said gray scale fingerprint image; and
(8) extracting a fingerprint template, wherein said steps constitute said method of capturing said fingerprint image by said camera.

2. A method of capturing a fingerprint image of claim 1, wherein said camera is a CMOS-based camera.

3. A method of capturing a fingerprint image of claim 1, wherein said camera is a CCD-based camera.

4. A method of capturing a fingerprint image of claim 1, wherein said camera captures said fingerprint image by a fixed focus.

5. A method of capturing a fingerprint image of claim 1, wherein said camera captures said fingerprint image by an automatic adjustment mechanism, which comprises AE (Auto Exposure), AF (Auto Focus) and AWB (Auto White Balance).

6. A method of capturing a fingerprint image of claim 1, wherein said image capture region has an image capture frame formed therein, and said image capture frame is in the shape of a circle, a rectangle, a square, or an irregular.

7. A method of capturing a fingerprint image of claim 1, wherein said image capture region is composed of a plurality of positioning dots, and can be chosen by a picking method

8. A method of capturing a fingerprint image of claim 1, wherein said image capture region is composed of a plurality of positioning symbols.
